(19) United States
(12) Patent Application Publication
(10) Pub. No.: US 2009/0023110 A1
(43) Pub. Date: Jan. 22, 2009

(54) TOOTH IMPLANT AND ABUTMENT FOR SUCH A TOOTH IMPLANT

(76) Inventor: Rolf SCHERBERGER, Muehlacker (DE)

Correspondence Address: HARNESS, DICKEY & PIERCE, P.L.C., P.O. BOX 828, BLOOMFIELD HILLS, MI, 48303, US

(21) Appl. No.: 12/182,760

(22) Filed: Jul. 30, 2008

Related U.S. Application Data
(63) Continuation of application No. PCT/EP2007/000817, filed on Jan. 31, 2007.

(30) Foreign Application Priority Data
Jan. 31, 2006 (DE) 10 2006 005 667.1

(51) Int. Cl. A61C 8/00

(52) U.S. Cl. 433/174

(57) ABSTRACT

The invention relates to a tooth implant (10) for application in the human jaw bone, with a cylindrical bore (20), which is open toward a distal end (16) and is designed to receive a longitudinal portion of an abutment (50), wherein a first longitudinal portion (22) of the bore (20) adjacent to the distal end (16) has a first cylindrical guide surface (28). In the area of the first longitudinal portion (22), at least two cams (30) are provided, which protrude radially inward and in each case have a second guide surface (36) lying concentric with respect to the first guide surface (FIG. 1b).

### CROSSREFERENCES TO RELATED APPLICATIONS

This application is a continuation of copending international patent application PCT/EP2007/000817 filed on Jan. 31, 2007 designating the U.S. and published in German, which claims priority of German patent application DE 10 2006 005 667 filed on Jan. 31, 2006. The entire contents of these priority applications are incorporated herein by reference.

### BACKGROUND OF THE INVENTION

The present invention relates to a tooth implant for application in the human jaw bone, with a cylindrical bore, which is open toward a distal end and is designed to receive a longitudinal portion of an abutment, wherein a first longitudinal portion of the bore adjacent to the distal end has a first cylindrical guide surface. The invention additionally relates to an abutment and a closure screw for such a tooth implant.

Tooth implants of the aforementioned type are generally known. A tooth implant is inserted into the human jaw bone and then serves to receive what is called an abutment. This abutment then supports, for example, the ceramic structure for formation of a tooth. The abutment is usually connected to the tooth implant by means of a screw, with additional means being provided in order to secure the connection between tooth implant and abutment against rotation.

In document DE 196 33 570, for example, a tooth implant is described into which an abutment (called a spacer sleeve in said document) can be inserted. To secure against rotation, form-fit cams are provided in a form-fit portion of the abutment and engage with grooves provided correspondingly in the tooth implant. In addition to the form-fit portion with the form-fit cams, the abutment in this known solution comprises a guide portion and a centering portion with a centering collar, these having the object of facilitating insertion of the abutment into the tooth implant and of holding the abutment free of play in the tooth implant.

Before an abutment is inserted into the tooth implant, the latter is closed by a closure screw during the healing process in the bone, such that the bore in the tooth implant is sealed off. To insert this closure screw, it is likewise necessary to ensure centering and guiding, so as to avoid the screw becoming wedged in the tooth implant. On account of the stepped design of the bore in the tooth implant provided in the above-mentioned document, a satisfactory guiding of the closure screw can be achieved only with difficulty, since the longitudinal portion suitable for this purpose in the tooth implant is located very far down, i.e. remote from the upper edge area. Consequently, the closure screw is guided only when it has already been almost completely inserted into the tooth implant.

### SUMMARY OF THE INVENTION

Against this background, the object of the present invention is to develop a tooth implant of the aforementioned type in such a way that, on the one hand, the guiding and protection against rotation are retained for the abutment and, on the other hand, good guiding of a closure screw is achieved. In addition, these functions are to be made available within the shortest possible area inside the tooth implant.

In the tooth implant mentioned at the outset, these and other objects are achieved by virtue of the fact that, in the area of the first longitudinal portion, at least two cams are provided, which protrude radially inward and in each case have a second guide surface lying concentric with respect to the first guide surface.

In other words, the inwardly directed surfaces of the cams have a curved surface and together lie on an imaginary cylinder surface, which is in turn concentric with respect to the inner face of the bore. By virtue of this design of the cams, it is now possible for a closure screw to be guided on these guide surfaces of the cams right at the start of the insertion procedure. Their curved shape means that they lie directly on the closure screw.

To provide protection against rotation, the abutment is provided with grooves into which the cams can engage.

It has thus been found that the protection against rotation for the abutment and also the guide function for a closure screw can be achieved with few measures within a very small space. In addition, a very large guide surface is available to the abutment in the area of the first longitudinal portion, such that the high forces that occur can be readily absorbed. Since the forces acting on a closure screw are very much lower, the much smaller guide surface offered by the cams is also sufficient for absorbing the forces.

It has thus been found that, with the solution according to the invention, a tooth implant has been created that optimally provides several functions within a very small space. The protection against rotation provided in the previous tooth implants has a further function in the solution according to the invention, such that it is possible to dispense with the additional means hitherto provided for this purpose.

According to a preferred development, at least three cams are provided which, in the circumferential direction of the first longitudinal portion, are arranged at a uniform distance from one another.

This measure has the advantage that the guiding of the closure screw is improved. The total of three cams has proven particularly advantageous here, with the distance between the cams being 120°.

In a preferred development, the cams each have a surface directed toward the proximal end of the bore and extending perpendicular to the first guide surface.

In other words, the underside of the cams extends perpendicular to the longitudinal axis of the tooth implant. These surfaces can be used for fixing purposes if the component inserted into the tooth implant is provided with corresponding projections that are able to engage with the cams of the tooth implant when the component is turned.

In a preferred development, a second longitudinal portion is provided which adjoins the proximal end of the first longitudinal portion and has a smaller diameter than the first longitudinal portion, wherein the diameter of the second longitudinal portion corresponds to the diameter on which the second guide surfaces of the cams lie.

This measure has the advantage that the closure screw can be of a very simple design, since the screw body only needs to have one diameter.

In a preferred development, the cams each have an upper surface directed toward the distal end and extending away to the first guide surface obliquely with respect to the proximal end.

In other words, the upper surfaces of the cams are arranged in a funnel shape and thus make it easier to insert the abutment into the bore of the tooth implant.

In a preferred development, the upper surfaces of the cams are arranged directly at the distal end of the bore.

This measure has the advantage that little space is needed in the tooth implant, and also that the guide function for the closure screw is quickly obtained.

The object of the invention is also achieved by an abutment which is adapted to the tooth implant according to the invention and which has a cylindrical longitudinal portion whose external diameter corresponds to the first guide surface and which has at least a number of grooves corresponding to the number of cams, said cams and grooves together serving as a means of protection against rotation. The grooves preferably have a conical longitudinal portion at their proximal end.

The last-mentioned measure has the advantage that the “threading” of the abutment into the tooth implant is made easier by the funnel-shaped grooves.

Finally, the present invention also relates to a closure screw adapted to the tooth implant according to the invention. The closure screw has a head, which closes the bore of the tooth implant, a guide portion adjoining the head, and a threaded portion that engages with the thread of the second longitudinal portion of the tooth implant. According to the invention, the diameter of the guide portion corresponds to the diameter formed by the second guide surfaces of the cams of the tooth implant.

By virtue of the fact that the lower end of the closure screw is screwed into the tooth implant and its upper end is guided by the cams of the tooth implant, an extraordinarily good connection is obtained between the tooth implant and the closure screw.

Further advantages and embodiments of the inventions are set forth in the description and the attached drawing.

It will be appreciated that the aforementioned features and those still to be explained below can be used not only in the respectively cited combination, but also in other combinations or singly, without departing from the scope of the present invention.

### BRIEF DESCRIPTION OF THE DRAWINGS

The invention is now explained in more detail on the basis of illustrative embodiments and with reference to the drawing, in which:

FIGS. 1a, b, c show side views of a tooth implant according to the invention, and a variation thereof;

FIG. 2 shows a schematic view of the tooth implant from above;

FIGS. 3a-d show different schematic views of an abutment according to the invention;

FIGS. 4a, b show schematic views of a closure screw which, in one view, is inserted in the tooth implant according to the invention; and

FIG. 5 shows a schematic view of a screw for securing the abutment in the tooth implant.

### DETAILED DESCRIPTION OF PREFERRED EMBODIMENTS

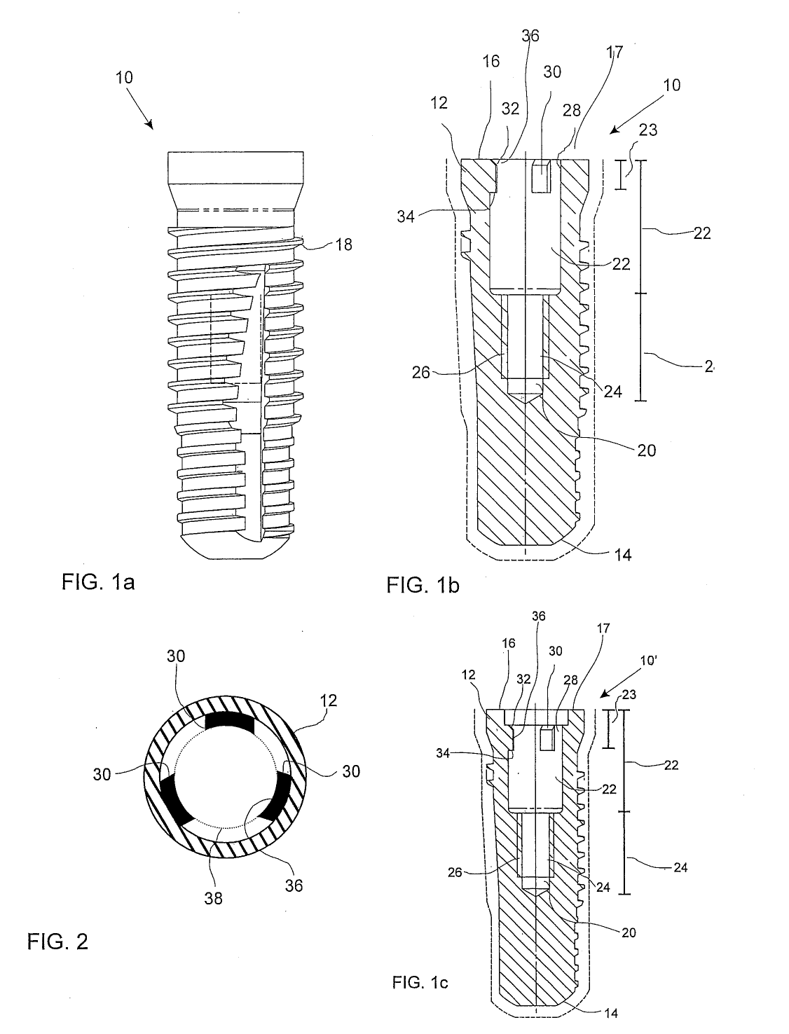

In FIG. 1, a tooth implant (hereinafter abbreviated to implant) is shown schematically and is designated by reference number 10. The implant 10 is made of a metal, preferably titanium, or a ceramic material. The implant 10 has an elongate, rotationally symmetrical structure, with a thread 18 provided on the outside. With the aid of this outer thread 18, the implant 10 can be screwed into the human (or animal) jaw bone and anchored therein.

The inner structure of the implant 10 can be seen in FIG. 1b. The implant 10 is composed of an implant body 12 with a proximal end 14 and a distal end 16. At the distal end 16 of the implant body 12, a bore 20 is provided that extends over a first longitudinal portion 22 and a second longitudinal portion 24 in the direction of the proximal end 14. It can be seen clearly in FIG. 1b that the diameter of the bore in the first longitudinal portion 22 is greater than the diameter in the second longitudinal portion 2. A step is thereby created at the bottom of the first longitudinal portion 22.

An inner thread 26 is provided in the second longitudinal portion 24 for the purpose of securing a screw.

FIG. 1b also shows that, at the distal end 16, there is an end face located between the bore 20 and the outer edge of the implant body 12.

The inside of the bore 20, in the area of the first longitudinal portion 22, is designed as a guide surface 28. This means that this bore has a particularly high degree of dimensional accuracy and good surface properties.

In an upper, third longitudinal portion 23, which begins directly at the end face 17, cams 30 are formed on the inner face of the bore 20. As can be seen clearly in FIG. 2, the cams 30 protrude radially inward and extend in the longitudinal direction of the implant body. The cams 30 have an upper flank 32, which is directed toward the distal end 16 and drops away obliquely toward the inside. The opposite lower flank 34, by contrast, is perpendicular to the longitudinal axis and to the first guide surface 28.

The cams 30 also have an inwardly directed surface 36, which is designed as a second guide surface. As will be seen from FIG. 2, the second guide surfaces 36 of the cams 30 are designed such that they lie on an imaginary circle 38. In other words, the radius of the curve of these two guide surfaces 36 corresponds to the radius of the circle 38 indicated by a broken line in FIG. 2. This diameter is also smaller than the diameter of the bore 20 in the first longitudinal portion 22 and corresponds to the diameter of the bore 20 in the second longitudinal portion 24.

In the present illustrative embodiment, three cams 30 are provided in total and are arranged uniformly at a distance of 120° from one another. However, the use of three cams has been chosen purely by way of example, and another number is likewise conceivable. It should be noted here, however, that although the use of just one cam may provide protection against rotation, this does not provide the additionally desired guide function.

It will also be seen from FIGS. 1 and 2 that the wall thickness of the implant body 12 in the area of the third longitudinal portion 23 is greater than in the subsequent longitudinal portion, in which the thread 18, inter alia, is provided. The external diameter of the thread 18 corresponds approximately to the external diameter of the implant body 12 in the area of the third longitudinal portion 23.

FIG. 1c shows an implant 10′ which is slightly modified compared to the one described above. The difference lies in the fact that the third longitudinal portion 23 is slightly lengthened, such that the cams 30 are at a distance from the upper end face 17. Moreover, the bore 20 has, in the upper part of the longitudinal portion 23, a slightly greater diameter than in the adjoining part in which the cams 30 lie.

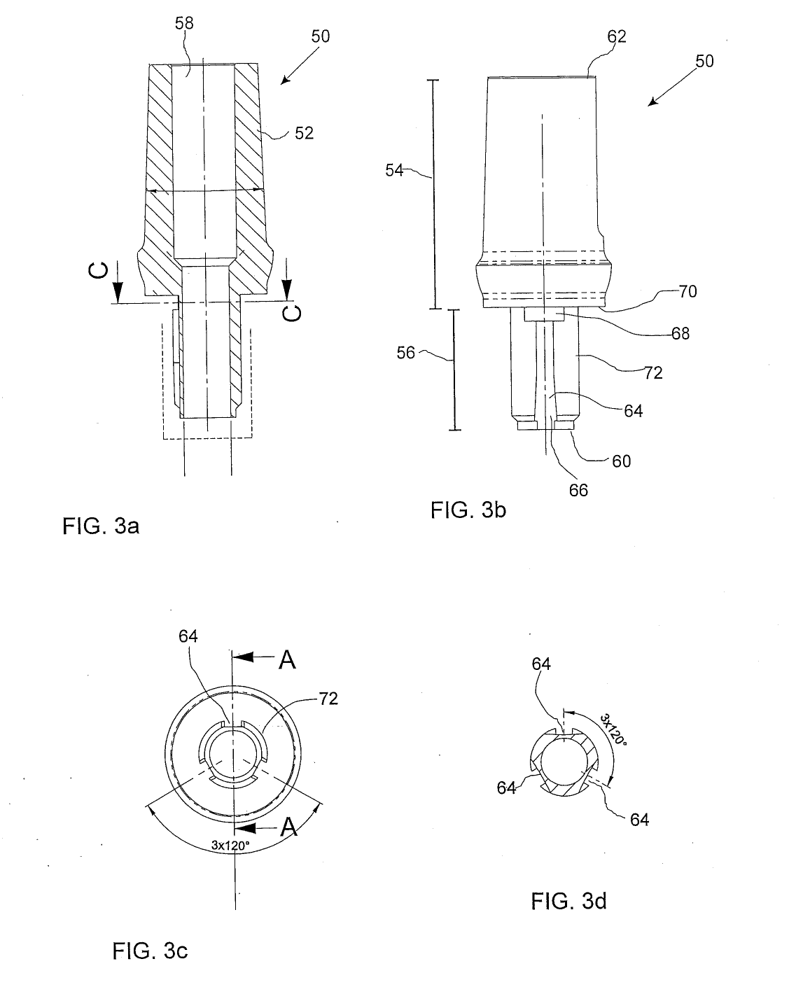

In FIGS. 3a to 3d, an abutment is shown schematically and is designated by reference number 50. This abutment 50 is secured in a tooth implant 10 and supports the ceramic structure, for example for a crown. Since the area of the abutment lying outside the tooth implant corresponds to the known structure, it will not be discussed in any more detail below.

The abutment 50 comprises an abutment body 52, which has a first longitudinal portion 54 and, adjacent to this, a second longitudinal portion 56. The first longitudinal portion 54 serves to receive a ceramic structure, while the second longitudinal portion 56 is inserted into the bore 20 of the implant 10.

The abutment 50 comprises a bore 58 extending from the proximal end 60 to the distal end 62. To secure the abutment 50 in the tooth implant 10, a screw is passed through this bore 58 and screwed firmly in the thread 26 of the implant 10.

The second longitudinal portion 56 has a cylindrical shape with a cylindrical outer surface, which serves as guide surface 72. The diameter of this portion 56 corresponds to the diameter of the bore 20 in the area of the first longitudinal portion 22. The first longitudinal portion 54 of the abutment 50 has a greater diameter, such that a step with a supporting surface 70 is created. In the inserted state, this supporting surface 70 rests on the end face 17 of the implant 10.

In the guide surface 72 of the abutment 50, grooves 64 are formed and extend parallel to the longitudinal axis. The grooves 64 extend from the lower proximal end 60 as far as the supporting surface 70 and are open toward the proximal end. The width of these grooves 64 corresponds at least to the width of the cams 30 of the tooth implant 10.

To make it easier to insert the abutment into the bore 20, the proximal portion 66 has a conical configuration, with the wider area lying at the proximal end 60. This funnel shape makes it easier to “thread” the cams 30 into the grooves 64.

As will be seen from FIGS. 3c and 3d, the present illustrative embodiment comprises three grooves 64, which are arranged at a distance of 120° from one another.

Consequently, the abutment 50 can be inserted into the implant 10 in several (three different) positions of rotation, with the cams 30 engaging in the grooves 64. This form-fit connection of cams and grooves provides the desired safety against rotation.

At the same time, the guide surface 72 of the abutment 50 interacts with the guide surface 28 in the first longitudinal portion 22 of the bore 20 and in this way ensures that the abutment is guided free of play during insertion and is held free of play in the inserted state.

The second guide surfaces 36 on the cams 30 have no function in this case.

It will also be noted here that the grooves 64, in the area of the supporting surface 70, open into an undercut 68 that opens the groove to left and right.

This measure is taken for reasons of production engineering and pre-vents the groove 64 from narrowing in the area of the supporting surface 70 during production.

As has already been mentioned, the abutment 50 is inserted into the implant 10 and is screwed into place with a screw that is fitted into the bore 51. Such a screw is shown schematically in FIG. 5 and is designated by reference number 90. The screw 90 comprises a shank 92 whose end is provided with a thread 94. The thickness of the shank 92 corresponds to the smaller diameter of the bore 58 in the abutment 50 (cf. FIG. 3a).

Finally, the screw 90 has a screw head 96 with a hexagon socket 98.

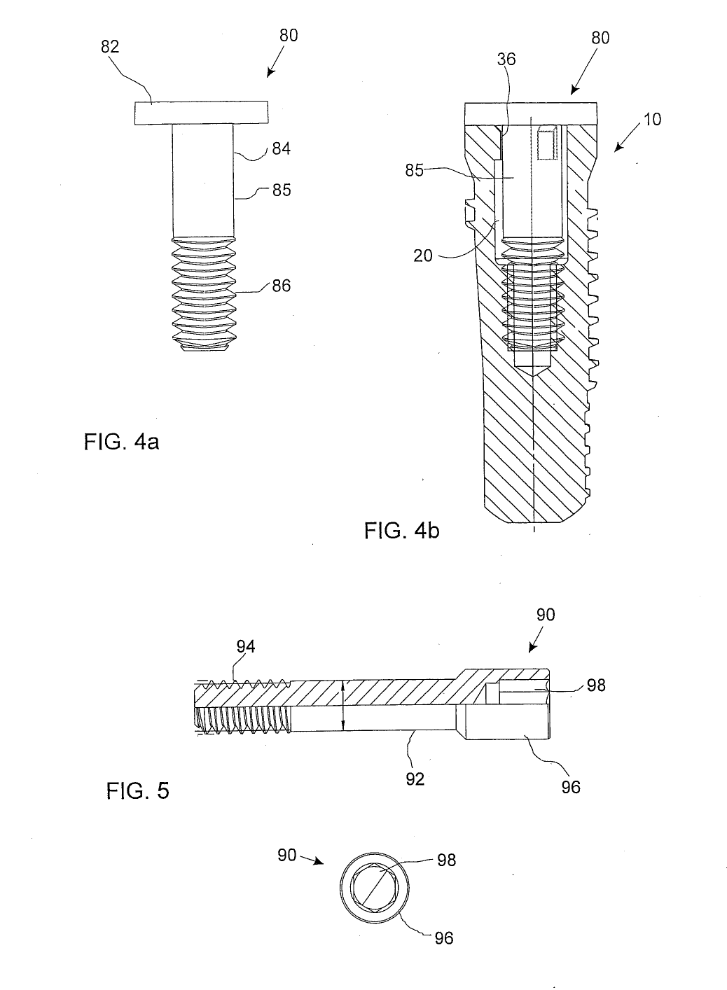

It is known that, when the implant 10 has been inserted into the jaw bone, it is not yet possible to insert the abutment 50. In order to seal off the bore 20 in the implant 10 during the healing phase, a closure screw is applied. Such a closure screw is shown schematically in FIG. 4a and is designated by reference number 80. The closure screw 80 comprises a covering cap 82 that covers the opening of the bore 20 in the tooth implant. The covering cap 82 is adjoined by a screw neck 84, which has a guide surface 85. Finally, at the lower end of the screw, there is a thread 86, which engages with the inner thread 26 of the implant 10 and whose diameter is smaller than or equal to the diameter of the guide surface 85.

The diameter of the guide surface 85 is chosen such that it corresponds to the diameter of the circle 38 shown in FIG. 2. The guide surfaces 36 of the cams 30 thus bear on the guide surface 85 as the screw is inserted. This can be clearly seen in FIG. 4b.

Since the guide surfaces 36 of the cams 30 start directly at the distal end 16 of the implant 10, the closure screw 80 is very soon guided by the engagement of the guide surface 85 with the guide surfaces 36 of the cams 30, such that it can be safely inserted and screwed into place.

In summary, therefore, it will be noted that the tooth implant 10 according to the invention protects against rotation and also guides a closure screw 80 inside a very short portion (longitudinal portion 23). While the side flanks of the cams 30 together with the grooves 64 provide the protection against rotation, the curved inner surfaces of the cams 30 serve as guide surfaces, which engage with a corresponding guide surface on the closure screw.

It will finally be noted that the embodiment shown is given purely by way of example and that variations are conceivable. For example, the number of cams in the implant can be readily increased. However, it should be ensured that the number of cams is an even-numbered multiple of the number of grooves in the abutment. It should also be noted that the abutment 50 has to be modified in the area of the longitudinal portion 56 if it is to be used with the implant 10′ in FIG. 1c. In particular, the undercut 68 can be omitted, since the groove 64 does not have to extend as far as the supporting surface 70. Other necessary changes arise directly from the design of the tooth implant 10′, such that details need not be given here.

Moreover, it will be noted that the guide surfaces of the cams can serve not just for guiding the closure screw. The cams can finally also serve as engagement surface for a screwing-in tool.

What is claimed is:

1. A tooth implant for application in the human jaw bone, having a cylindrical bore, which is open toward a distal end for receiving a longitudinal portion of an abutment, wherein a first longitudinal portion of the bore adjacent to the distal end has a first cylindrical guide surface, wherein, in the area of the first longitudinal portion, at least two cams are provided, which protrude radially inward and in each case have a second guide surface lying concentric with respect to the first guide surface.

2. The tooth implant as claimed in claim 1, wherein at least three cams are provided which, in the circumferential direction of the first longitudinal portion, are arranged at a uniform distance from one another.

3. The tooth implant as claimed in claim 1, wherein the cams each have a surface directed toward the proximal end of the bore and extending perpendicular to the first guide surface.

4. The tooth implant as claimed in claim 1, wherein a second longitudinal portion adjoins the proximal end of the first longitudinal portion and has a smaller diameter than the first longitudinal portion, characterized in that the diameter of the second longitudinal portion corresponds to the diameter of the circle on which the second guide surfaces of the cams lie.

5. The tooth implant as claimed in claim 1, wherein the cams each have an upper surface directed toward the distal end and falling away to the first guide surface obliquely with respect to the proximal end.

6. The tooth implant as claimed in claim 4, wherein the second longitudinal portion has a thread.

7. The tooth implant as claimed in claim 1, wherein an outer thread is provided which, starting from the proximal end, extends at least over part of the length of the tooth implant.

8. The tooth implant as claimed in claim 1, wherein the upper surfaces of the cams are arranged directly at the distal end of the bore.

9. The tooth implant as claimed in claim 1, wherein, in the longitudinal direction of the bore, the cams extend over part of the length of the first longitudinal portion.

10. An abutment device for a tooth implant for application in the human jaw bone, wherein the tooth implant has a cylindrical bore which is open toward a distal end and is designed to receive a longitudinal portion of the abutment device, wherein a first longitudinal portion of the bore adjacent to the distal end has a first cylindrical guide surface, wherein, in the area of the first longitudinal portion, at least two cams are provided, which protrude radially inward and in each case have a second guide surface lying concentric with respect to the first guide surface, and wherein said abutment device comprises a cylindrical longitudinal portion whose external diameter corresponds to the diameter of the first guide surface and which has at least a number of grooves corresponding to the number of cams, said cams and grooves together serving to prevent rotation of said abutment device relative to said tooth implant.

11. The device as claimed in claim 10, characterized in that the grooves have a conical longitudinal portion at their proximal end.

12. The device as claimed in claim 10, wherein at least three cams are provided which, in the circumferential direction of the first longitudinal portion, are arranged at a uniform distance from one another.

13. The device as claimed in claim 10, wherein the cams each have a surface directed toward the proximal end of the bore and extending perpendicular to the first guide surface.

14. The device as claimed in claim 10, wherein the tooth implant has a second longitudinal portion which adjoins the proximal end of the first longitudinal portion and has a smaller diameter than the first longitudinal portion, characterized in that the diameter of the second longitudinal portion corresponds to the diameter of the circle on which the second guide surfaces of the cams lie.

15. The device as claimed in claim 10, wherein the cams each have an upper surface directed toward the distal end and falling away to the first guide surface obliquely with respect to the proximal end.

16. The device as claimed in claim 14, wherein the second longitudinal portion has a thread.

17. The device as claimed in claim 10, wherein an outer thread is provided which, starting from the proximal end, extends at least over part of the length of the tooth implant.

18. The device as claimed in claim 10, wherein the upper surfaces of the cams are arranged directly at the distal end of the bore.

19. The device as claimed in claim 10, wherein, in the longitudinal direction of the bore, the cams extend over part of the length of the first longitudinal portion.

20. A closure screw device for a tooth implant for application in the human jaw bone, wherein the tooth implant has a cylindrical bore, which is open toward a distal end and is designed to receive a longitudinal portion of an abutment, wherein a first longitudinal portion of the bore adjacent to the distal end has a first cylindrical guide surface, wherein, in the area of the first longitudinal portion, at least two cams are provided, which protrude radially inward and in each case have a second guide surface lying concentric with respect to the first guide surface, and wherein said closure screw device comprising a head, which closes the bore of the tooth implant, a guide portion adjoining the head, and a threaded portion that engages with the thread of the second longitudinal portion of the tooth implant, wherein the diameter of the guide portion corresponds to the diameter formed by the second guide surfaces of the cams of the tooth implant.
